(19) United States
(12) Patent Application Publication
(10) Pub. No.: US 2008/0222012 A1
(43) Pub. Date: Sep. 11, 2008

(54) System and method for advertising online vehicle sales

(75) Inventor: Pawan Rajpanth Murthy, Powell, OH (US)

Correspondence Address: CROWELL & MORING LLP;INTELLECTUAL PROPERTY GROUP, P.O. BOX 14300, WASHINGTON, DC, 20044-4300, US

(73) Assignee: BAYERISCHE MOTOREN WERKE AKTIENGESELLSCHAFT, Muenchen (DE)

(21) Appl. No.: 11/715,578

(22) Filed: Mar. 7, 2007

(51) Int. Cl. G06Q 30/00; G06Q 90/00

(52) U.S. Cl. 705/27

(57) ABSTRACT

Vehicle information is provided by a private seller of a vehicle over a network to an online vehicle transaction server. A periodic payment amount is then calculated for the vehicle based on the provided vehicle information, as well as certain predetermined financing terms. In one embodiment a vehicle advertisement number is generated for the subject vehicle, and may serve as a identifier or online pointer to a webpage containing the subject vehicle's information, including the previously-calculated periodic payment amount. In embodiment, a vehicle advertisement document may be generating to include the vehicle advertisement number and the vehicle's sales price represented as the previously-calculated periodic payment amount. The advertisement document may be downloaded by the private vehicle seller and placed in the subject vehicle as a sale sign.

### FIELD OF THE INVENTION

The present invention relates, in general, to online vehicle sales and, more particularly, to advertising and effectuating online private party vehicle sales.

### BACKGROUND OF THE INVENTION

The number of vehicles being sold by private parties has been increasing dramatically over the last few years. In fact, research now suggests that there are over 4 million vehicle sales per year that do not involve a licensed vehicle dealer. In addition, most such private party vehicle transactions require financing. As such, vehicle finance companies primarily target the buyer in their advertisements. This is due in large part to the fact that the buyers are the ones that are considered the main source of revenue since profit is made on buyer's loan interest. Thus, over 4 million vehicle sellers are being left largely ignored by vehicle finance companies since there is no direct way to generate revenues from these individuals.

Moreover, little innovation has taken place in the area of private party vehicle sales advertisement. Most such advertisement occur in classified ads in newspapers, or on classified websites, such as www.craigslist.com or www.ebay.com. Typically, such advertisements simply list the vehicle specifics, the total sales price and some contact information for the seller (e.g., telephone number, email address, etc.). This advertising methodology makes for an inefficient and generally disorganized approach for private parties to sell their vehicles. Accordingly, there is a need in the art for advertising online private party vehicle sales.

### BRIEF SUMMARY OF THE INVENTION

Disclosed and claimed herein is an approach for advertising online private party vehicle sales. In one embodiment, a method includes receiving vehicle information over a network from a private seller of a vehicle, calculating a periodic payment amount for the vehicle based on the vehicle information and predetermined financing terms, and generating a vehicle advertisement number corresponding to the vehicle information and to the periodic payment amount. The method further includes generating an advertisement for the vehicle, where the advertisement includes the vehicle advertisement number and a vehicle sales price represented as the periodic payment amount.

In another embodiment, a vehicle transaction server comprises a network interface configured to couple the vehicle transaction server to a network, a memory containing computer-executable instructions, and a processor coupled to the network interface and to the memory. In one embodiment, the processor is configured to execute the computer-executable instructions to receive vehicle information over the network from a private seller of a vehicle, calculate a periodic payment amount for the vehicle based on the vehicle information and predetermined financing terms, and generate a vehicle advertisement number corresponding to the vehicle information and the periodic payment amount. The processor is further configured to generate an advertisement for the vehicle which includes said vehicle advertisement number and a vehicle sales price represented by said periodic payment amount.

Other aspects, features, and techniques of the invention will be apparent to one skilled in the relevant art in view of the following detailed description of the invention.

### BRIEF DESCRIPTION OF THE DRAWINGS

FIG. 1 depicts one embodiment of a simplified system diagram showing the network connectivity between one or more elements of the invention;

FIGS. 2A-2D depicts various embodiments of graphical user interfaces usable by a private vehicle seller in connection with one embodiment of the invention;

FIG. 2E depicts a vehicle advertisement document in accordance with one embodiment of the invention;

FIG. 3 depicts a sequence of graphical user interfaces usable by a potential vehicle buyer in connection with one embodiment of the invention;

FIG. 4 depicts one embodiment of a process for carrying out one or more aspects of the invention; and

FIG. 5 depicts another embodiment of a process for carrying out one or more aspects of the invention.

### DETAILED DESCRIPTION OF EXEMPLARY EMBODIMENTS

### Overview of the Disclosure

The present disclosure relates generally to advertising online private party vehicle sales. As will be described in more detail below, vehicle information is provided by a private seller of a vehicle over a network to an online vehicle transaction server using, for example a series of server-generated graphical user interfaces (GUIs). Such vehicle information may include, for example, a total vehicle sales price, a vehicle make, a vehicle model, a vehicle year of manufacturer, and a vehicle identification number (VIN).

In certain embodiments, a periodic payment amount is then calculated for the vehicle based on the provided vehicle information, as well as certain predetermined financing terms. Such financing terms may include, for example, the amount of time the vehicle will be financed, the buyer's credit rating, the prevailing interests rates and so forth. While in one embodiment the periodic payment amount is a monthly payment amount for the subject vehicle, it should equally be appreciated that the amount may be representative of other payment periods as well.

Another aspect of the invention is to generate a vehicle advertisement number which corresponds to the previously-provided vehicle information and the previously-calculated periodic payment amount. In one embodiment, this vehicle advertisement number may serve as an identifier or online pointer to a webpage containing the subject vehicle's information, including the previously-calculated periodic payment amount.

In another embodiment, a vehicle advertisement document may be generating in response to a seller request, where such advertisement document includes the vehicle advertisement number and the vehicle's sales price represented as said periodic payment amount. Once generated, this advertisement document may be transmitted by the vehicle transaction sever over the network to the private vehicle seller to be placed in the subject vehicle and to function as a sale sign. In another embodiment, the advertisement document may be a brochure or include any other type of advertising materials. Regardless of form, in certain embodiments, the vehicle advertisement document may include the vehicle advertisement number, the vehicle sales price represented as the periodic payment amount, a vehicle make, a vehicle model, a vehicle year of manufacturer. It should be appreciated that, while seller contact information may be included, it need not be since the vehicle advertisement number may be used by a potential buyer to locate and purchase the vehicle online.

As used herein, the terms “a” or “an” shall mean one or more than one. The term “plurality” shall mean two or more than two. The term “another” is defined as a second or more. The terms “including” and/or “having” are open ended (e.g., comprising). Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner on one or more embodiments without limitation. The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

In accordance with the practices of persons skilled in the art of computer programming, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The code segments can be stored in a processor readable medium, which may include any medium that can store or transfer information. Examples of the processor readable mediums include an electronic circuit, a semiconductor memory device, a read-only memory (ROM), a flash memory or other non-volatile memory, a floppy diskette, a CD-ROM, an optical disk, a hard disk, a fiber optic medium, a radio frequency (RF) link, etc.

### Exemplary Embodiments

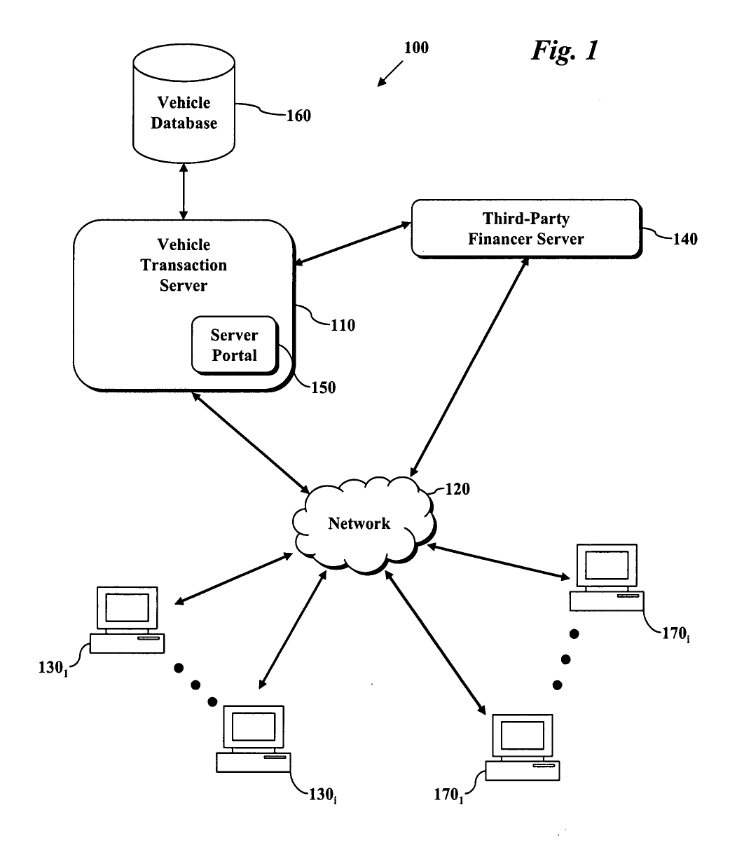

Referring now to the figures, FIG. 1 depicts an exemplary embodiment of a network system 100 for carrying out one or more aspects of the invention. In this embodiment, the vehicle transaction server 110 is accessible via a communication link with network 120 by private sellers 130₁-130ᵢ (“130”). Network 120 may include any variety of computer networks such as the Internet, a private intranet, a public switch telephone network (PSTN), or any other type of network known in the art. As will be described in more detail below, private sellers 130 may access the vehicle transaction server 110 for the purpose of effectuating online private vehicle sales, the advertisement thereof, and financing vehicle purchases.

The vehicle transaction server 110 may comprise one or more computer systems that execute one or more software modules for performing the vehicle transactions and advertisement functions disclosed herein. As will be described in more detail below, vehicle transaction server 110 may implement vehicle sales advertisement functions, vehicle sales/purchase functions, and vehicle financing functions. However, it should be appreciated that at least some of the vehicle financing functions to be described herein may be equally performed by a third-party via a third-party financier server 140.

In one embodiment, the vehicle transaction server 110 may comprise a server portal 150 usable by private seller 130 to access one or more of these software modules. In certain embodiments, the server portal 150 may comprise a series of web pages containing GUIs configured to receive and provide vehicle advertisement and transaction-effectuating information.

To that end, private sellers 130 may access the vehicle transaction server 110 by directing a browser application (e.g., Netscape Navigator™, Microsoft Internet Explorer™, etc.) to a network address (e.g., uniform resource locator) corresponding to the server portal 150. It should equally be appreciated that numerous other network configurations may be used which provide private seller access to the functions performed by the vehicle transaction server 110, as further detailed below.

The vehicle transaction server 110 may further be in communication with one or more vehicle databases 160, which contain vehicle data representative of a plurality of vehicles available for sale from the private sellers 130. Vehicle databases 160 may further contain vehicle pricing information. While in certain embodiments the vehicle databases 160 may be local to the vehicle transaction server 110, in other embodiments it may be remotely located and maintained, such as by a third-party server.

Continuing to refer to FIG. 1, the vehicle transaction server 110 is further accessible via network 120 by potential buyers 170₁-170ᵢ (“170”). Such potential buyers 170 may access the vehicle transaction server 110 for the purpose of effectuating a vehicle sale with one of the private sellers 130, which in the transaction amount may be financed by an operator of the vehicle transaction server 110 or by an operator of the third-party financier server 140.

While vehicle transaction server 110 and vehicle database 160 have been depicted in FIG. 1 as separate and distinct systems, it should equally be appreciated that the operations carried out by each may be integrated into and carried out by any number of servers or other processing units.

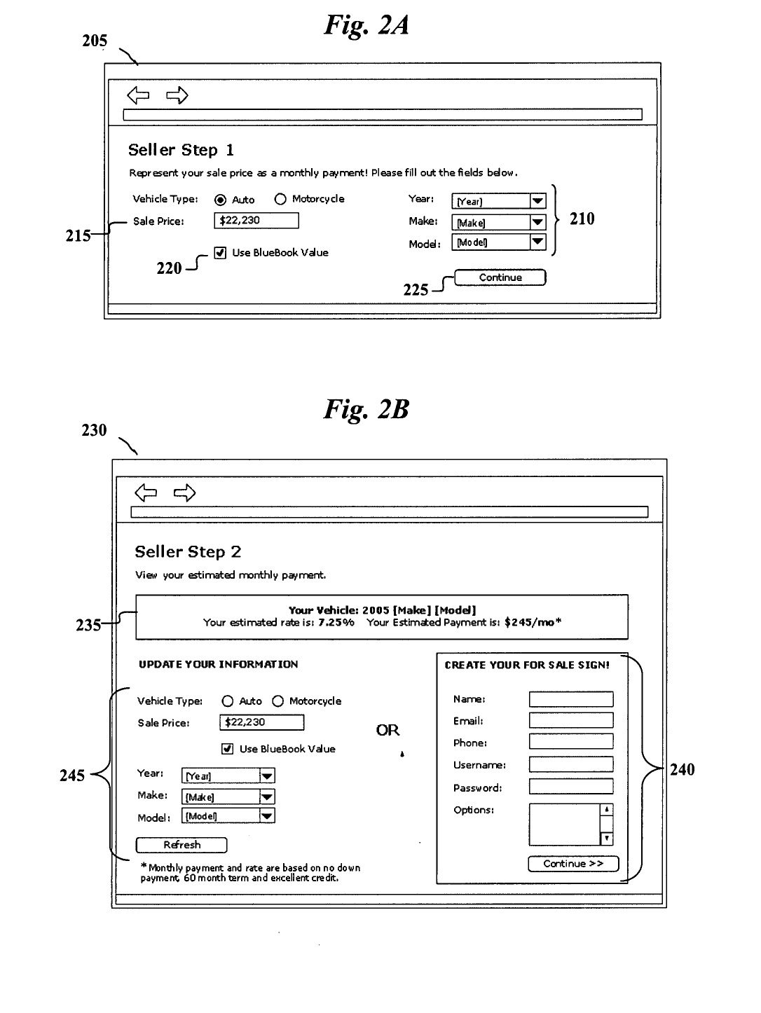

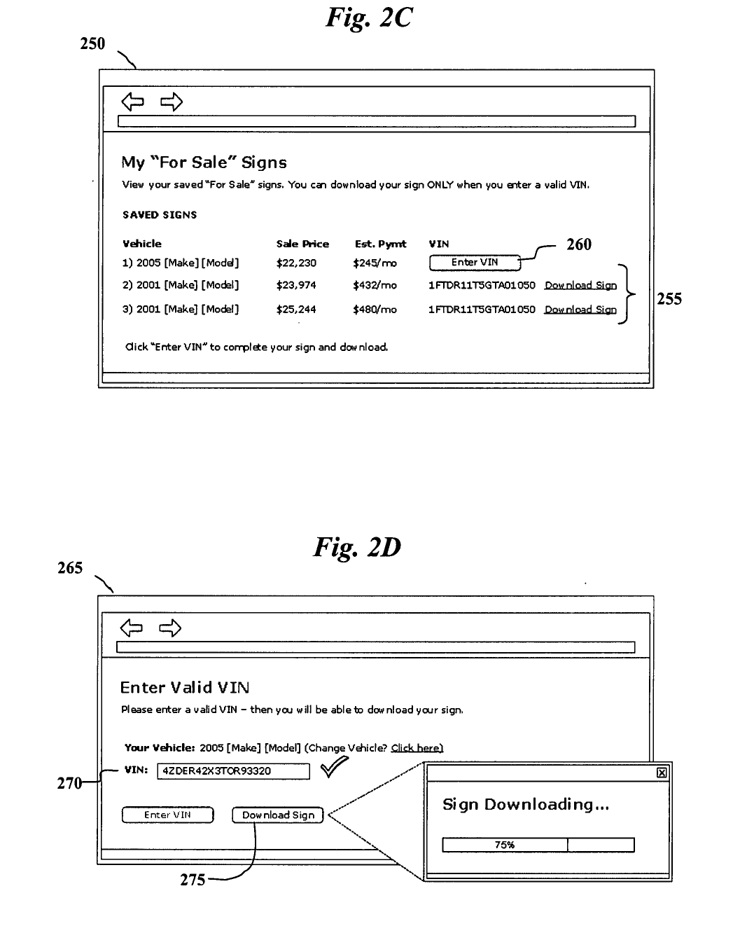

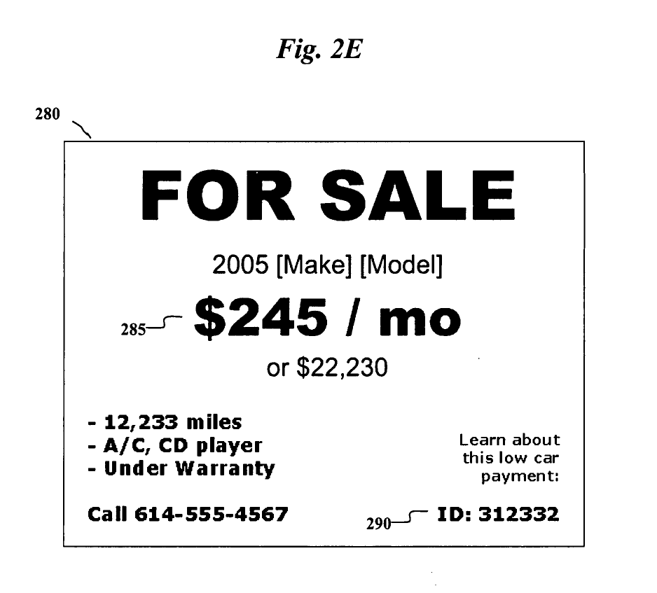

FIGS. 2A-2D depict a series of exemplary GUIs usable to effectuate one or more aspects of the invention. It should be appreciated that the GUIs described herein are simplified wireframe versions of exemplary GUIs, and any number of variations thereon would be consistent with the principles of the invention.

FIG. 2A, for example, depicts one embodiment of an exemplary GUI 205 usable by a private vehicle seller (e.g., vehicle seller 130 of FIG. 1) to provide vehicle information to an online vehicle transaction server (e.g., vehicle transaction server 110 of FIG. 1). In the embodiment of FIG. 2, the GUI 205 includes a plurality of vehicle information fields 210 for entering such information as the vehicle's make, the model and the year of manufacture. GUI 205 is further depicted as including a sales price field 215 and a bluebook value field 220. In one embodiment, the bluebook value field 220 may be used to automatically populate the sales price field 215 with a third-party estimate of a fair sale price for the subject vehicle. Alternatively, a private seller may simply manually fill in the sales price field 215. It should be appreciated that GUI 205 need not include all of the aforementioned fields, or alternatively may have other fields in addition thereto.

Once the requisite vehicle information has been entered into fields 210-220, the private seller may then press a “continue” button 225 or other input indication to submit the information to the online vehicle transaction server. To that end, FIG. 2B depicts an exemplary embodiment of a GUI 230 which may be presented to a private seller following the submission of vehicle information, such as the information entered and submitted using GUI 205 of FIG. 2A. As shown in FIG. 2B, GUI 230 includes a financing summary 235, a sale sign creation box 240, and a plurality of vehicle information update fields 245. From this GUI 230, the private vehicle seller will be able to automatically view the sales price of the vehicle represented as a periodic payment amount. In this embodiment, the periodic payment amount is represented as a monthly payment (i.e., $245/mo.). In addition thereto, the financing summary 235 may include some or all of the predetermined financing terms on which the periodic payment amount is based (e.g., interest rate, term of repayment, assumed credit rating, etc.). At this point, the private seller may proceed in at least one of two ways. First, the private seller may update the previously-provided vehicle information using the plurality of vehicle information update fields 245, or second, the private seller may request that an advertising sales sign be created using the various dialog boxes shown as sale sign creation box 240. Although not shown, it should further be appreciated that GUI 230 may include additional options of the private seller to alter the predetermined financing terms on which the periodic payment amount is based.

Referring now to FIG. 2C, depicted is another GUI 250 usable in connection with one embodiment of the invention. In particular, GUI 250 may be displayed to a private seller in response to the seller's input of certain sale sign information (e.g., using sale sign creation box 240 of FIG. 2B). It should be appreciated that the seller may be requested to log in to a seller account prior to being able to access GUI 250. From this GUI 250, a private vehicle seller may compare and select from a number of previously-created signs 255. Alternatively, the vehicle seller may complete the creation of a new sale sign by electing to enter a VIN number using button 260, for example.

To that end, FIG. 2D depicts still another GUI 265 which may be presented to a seller in response to depressing button 260. As shown, the seller may be presented with a field 270 for entering the subject vehicle's VIN. In one embodiment, the entered VIN may be validated against the subject vehicle's make, model and year. Once a valid VIN has been entered, selecting download sign button 275 will result in the downloading of an electronic file containing the created vehicle sale sign, according to one embodiment.

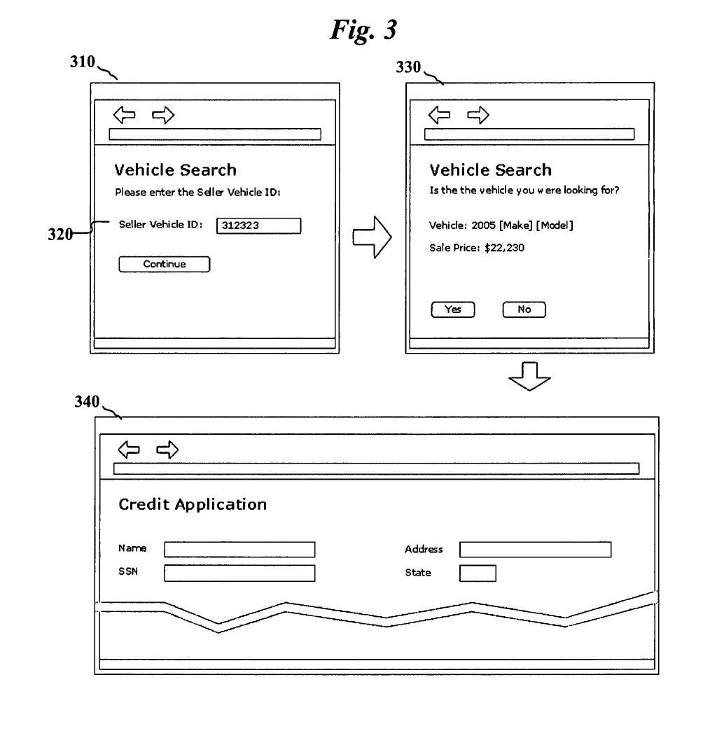

FIG. 2E depicts one embodiment of one such possible downloaded sale sign which, in one embodiment, is configured to be placed in the subject vehicle and to function as a sale sign for the vehicle. As shown, sale sign 280 includes a predominately displayed periodic payment amount 285 for the subject vehicle. The sale sign 280 may further include other vehicle specifics, such as make, model, year of manufacture, mileage, options, seller contact information, etc. In addition, the sale sign 280 includes a vehicle advertisement number 290. As will be described in more detail below with reference to FIG. 3, the vehicle advertisement number 290 may be usable by a potential buyer to access an online resource (e.g., webpage) for viewing the vehicle information, periodic payment amount, additional transaction details, as well as for potentially purchasing and financing the subject vehicle.

Although not depicted in FIG. 3, it should further be appreciated that the sale sign 280 may be generated to automatically include certain legal disclaimers and additional information where to access the vehicle transaction server (e.g., URL) for entering the vehicle advertisement number. Alternatively, or in addition thereto, a personalized vehicle brochure may be generated and downloaded by the private seller. In addition to all of the aforementioned information, such a brochure may include additional details/benefits of the vehicle transaction server, available financing options, etc.

With reference now to FIG. 3, depicted is a series of exemplary GUIs usable to effectuate one or more aspects of the invention. In particular, GUI 310 is an exemplary GUI served by a vehicle transaction server (e.g., vehicle transaction server 110 of FIG. 1), and usable by a potential buyer (e.g., potential buyer 170 of FIG. 1) to effectuate an online vehicle purchase. By entering a vehicle advertisement number (e.g., vehicle advertisement number 290) into field 320, the potential buyer may perform a vehicle search of a database of the vehicle transaction server (e.g., vehicle database 160) to locate/access vehicle information and the periodic payment amount for the subject vehicle. In short, the vehicle advertisement number is usable by potential buyers to access an online resource (e.g., webpage) corresponding to a particular vehicle that is offered for sale.

Continuing to refer to FIG. 3, in the event that a valid vehicle advertisement number has been entered, GUI 330 may be presented to the potential buyer. If the potential buyer is interested in purchasing and financing the vehicle, the vehicle transaction server may receive consumer credit and related information using GUI 340. From this point, either the vehicle transaction server, or a third-party financier server (e.g., third-party financer server 140 of FIG. 1) may process the financing request for the vehicle based at least in part on a credit rating of the potential buyer.

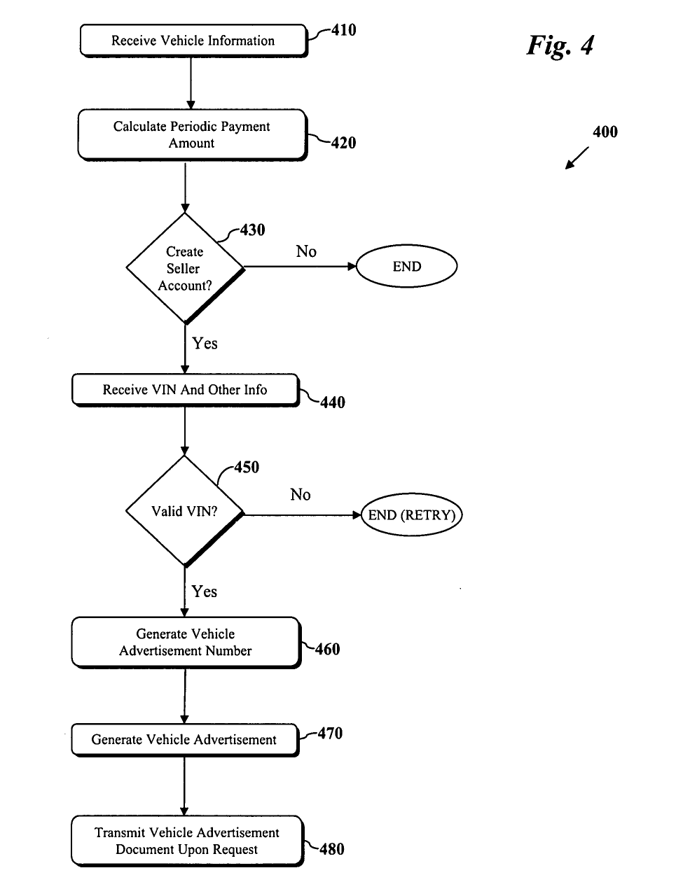

Referring now to FIG. 4, depicted is a process 400 which may be carried out by a vehicle transaction server in accordance with one embodiment of the invention. In particular, process 400 begins at block 410 where vehicle information may be received from a private seller submitted over a network (e.g., network 120 of FIG. 1). In the embodiment, such information may be submitted by entering information into one or more fields of a GUI (e.g., GUI 205 of FIG. 2A) served by the vehicle transaction server. Such vehicle information may include, for example, the subject vehicle's make, model, year of manufacture, mileage, options, total sales price, etc.

Process 400 may then continue to block 420 where a periodic payment amount may be calculated. In certain embodiments, the periodic payment amount for the subject vehicle may be calculated based on the aforementioned vehicle information from block 410, as well as predetermined financing terms (e.g., assumed finance period, assumed buyer's credit rating, prevailing interests rates, etc.). Once calculated, the periodic payment amount may be automatically communicated/displayed to the seller (e.g., GUI 230 of FIG. 2B).

Thereafter, at block 430, a determination may be made as to whether the seller desires to create an account or not. If not, process 400 may end. If, on the other hand, the private seller desires to proceed, a seller account may be established by entering the subject vehicle's VIN and other related seller/vehicle information at block 440. Upon receipt of a VIN, process 400 may continue to block 450 where a determination is made as to whether the entered VIN is valid or not. This may be done by comparing the VIN against the subject vehicle's make, model and year. Once a valid VIN has been entered, process 400 may continue to block 460 where a vehicle advertisement number (e.g., vehicle advertisement number 290 of FIG. 2E) may be generated for the subject vehicle. In one embodiment, the vehicle advertisement number may serve as a convenient identifier for buyers interested in the subject vehicle. In one embodiment, the private seller, seller's vehicle information and the corresponding vehicle advertisement number may all be stored in a database of the vehicle transaction server. In this fashion, a potential buyer may initiate the online purchase/finance process by simply accessing the vehicle transaction server (e.g., via server portal 150 of FIG. 1) and entering in the vehicle advertisement number corresponding to the vehicle of interest. In one embodiment, the potential buyer may have learned of the vehicle advertisement number by viewing a sale sign (e.g., sale sign 280 of FIG. 2E) posted in the subject vehicle.

Continuing to refer to FIG. 4, process 400 continues to block 470 where a vehicle advertisement document may be generated. In one embodiment, the vehicle advertisement document generated at block 470 may comprise a sale sign that is configured to be placed in the subject vehicle and to function as a sale sign for the vehicle, such as previously depicted sale sign 280 of FIG. 2E. In addition, to predominately displaying the periodic payment amount calculated above at block 420, vehicle advertisement document may further include other vehicle specifics, such as make, model, year of manufacture, mileage, options, seller contact information, etc. Moreover, the vehicle advertisement document may be generated to automatically include certain legal disclaimers and additional information on where to access the vehicle transaction server (e.g., URL) for entering the vehicle advertisement number. In certain embodiments, the vehicle advertisement document may comprise a personalized vehicle brochure which in addition to all of the information described above, may further include additional details/benefits of the vehicle transaction server, available alternative financing options, etc.

Thereafter, process 400 may continue to block 480 where the generated vehicle advertisement document may be transmitted to the private vehicle seller over the network. In one embodiment, this transmission may be in response to receiving a download request. In certain embodiments, the operation of block 480 may comprise downloading an electronic file which contains the created vehicle advertisement document (e.g., via GUI 265 of FIG. 2D).

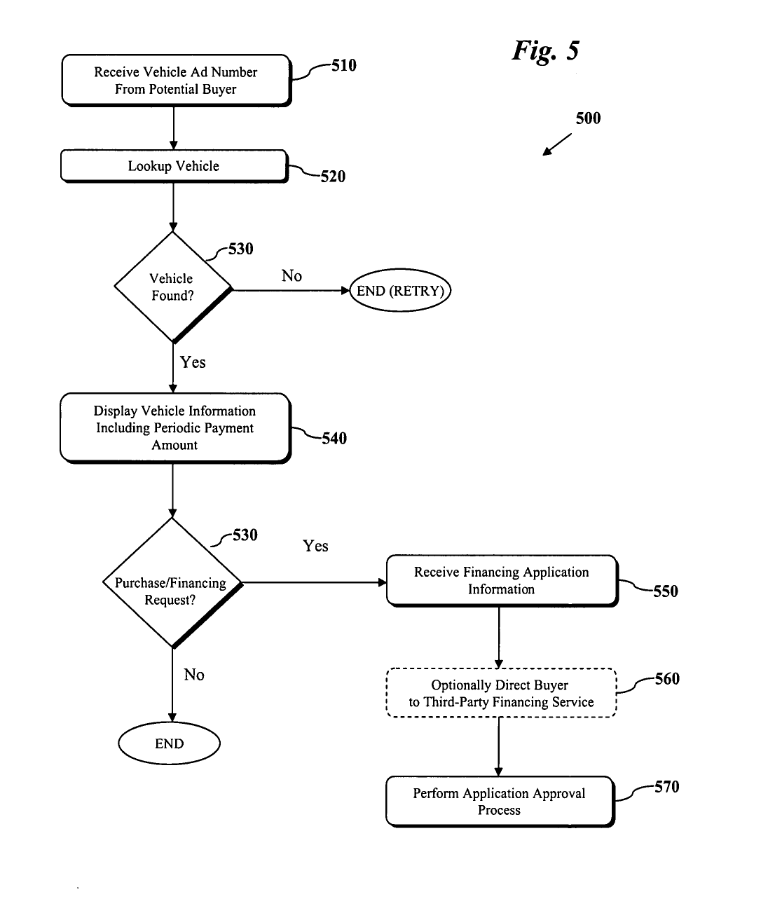

Referring now to FIG. 5, depicted is a process 500 which may also be carried out by a vehicle transaction server in accordance with one embodiment of the invention. In particular, process 500 begins at block 510 where a vehicle advertisement number is received from a potential buyer. As described above with reference to FIG. 3, a potential buyer may enter the vehicle advertisement number into a GUI served by the vehicle transaction server (e.g., GUI 310 of FIG. 3). Once a valid vehicle advertisement number is received, process 500 may continue to block 520 where a lookup operation may be performed to locate the desired vehicle. In one embodiment, the operation of block 520 may comprise a search of a database of the vehicle transaction server (e.g., vehicle database 160).

Once the subject vehicle is found (block 530), process 500 may continue to block 540 where the corresponding vehicle information and the periodic payment amount for the subject vehicle are displayed to the potential buyer (e.g., GUI 330 of FIG. 3). Thereafter, process 500 continues to decision block 530 where a determination may be made as to whether the potential buyer has requested to purchase and/or finance the subject vehicle. If not, process 500 may end. However, if the potential buyer has requested to purchase and/or finance the subject vehicle, process 500 may move to block 550 where financing application information may be received from the potential buyer (e.g., GUI 340 of FIG. 3). While in one embodiment, the vehicle transaction server may process the financing aspect of the online vehicle transaction, in another embodiment the buyer may be optionally directed to a third-party financing service at block 560 (e.g., third-party financier server 140). In either case, process 500 concludes at block 570 with the performance of the application approval process. In this fashion, the vehicle advertisement number may be usable by potential buyers to access an online resource (e.g., webpage) of a vehicle transaction server corresponding to a particular vehicle that is offered for sale, and then to consummate the sale through the same vehicle transaction server.

While the invention has been described in connection with various embodiments, it should be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for advertising online private party vehicle sales comprising the acts of:
receiving vehicle information over a network from a private seller of a vehicle;
calculating a periodic payment amount for said vehicle based on said vehicle information and predetermined financing terms;
generating a vehicle advertisement number corresponding to said vehicle information and said periodic payment amount; and
generating an advertisement for said vehicle that includes said vehicle advertisement number and a vehicle sales price represented by said periodic payment amount.

2. The method of claim 1, wherein receiving vehicle information comprising receiving said vehicle information into a graphical user interface of a online vehicle transaction server.

3. The method of claim 1, wherein said vehicle information includes one or more of the vehicle sales price, a vehicle make, a vehicle model, a vehicle year of manufacturer, and a vehicle identification number (VIN).

4. The method of claim 3, wherein calculating the periodic payment amount comprises calculating a monthly payment for said vehicle based on the predetermined financing terms and the vehicle sales price.

5. The method of claim 1, further comprising the act of transmitting, over the network, a vehicle advertisement document configured to be placed in said vehicle and to function as a sale sign for said vehicle.

6. The method of claim 5, wherein said vehicle advertisement document includes said vehicle advertisement number, the vehicle sales price represented by said periodic payment amount, a vehicle make, a vehicle model, a vehicle year of manufacturer, and seller contact information.

7. The method of claim 1, further comprising the acts of:
receiving the advertisement number over the network from a potential buyer;
accessing said vehicle information and periodic payment amount using said advertisement number; and
displaying said vehicle information and periodic payment amount to said potential buyer.

8. The method of claim 7, further comprising the acts of:
receiving a financing request for the vehicle over the network; and
processing said financing request for the vehicle based at least in part on a credit rating of said potential buyer.

9. A vehicle transaction server comprising:
a network interface configured to couple the vehicle transaction server to a network;
a memory containing computer-executable instructions; and
a processor coupled to the network interface and to the memory, said processor to execute the computer-executable instructions to:
receive vehicle information over the network from a private seller of a vehicle,
calculate a periodic payment amount for said vehicle based on said vehicle information and predetermined financing terms,
generate a vehicle advertisement number corresponding to said vehicle information and said periodic payment amount, and
generate an advertisement for said vehicle which includes said vehicle advertisement number and a vehicle sales price represented by said periodic payment amount.

10. The vehicle transaction server of claim 9, wherein the processor is further to execute the computer-executable instructions to generate a graphical user interface configured to receive said vehicle information from the private seller.

11. The vehicle transaction server of claim 9, wherein said vehicle information includes one or more of the vehicle sales price, a vehicle make, a vehicle model, a vehicle year of manufacturer, and a vehicle identification number (VIN).

12. The vehicle transaction server of claim 11, wherein said processor is to calculate the periodic payment amount by calculating a monthly payment for said vehicle based on the predetermined financing terms and the vehicle sales price.

13. The vehicle transaction server of claim 9, wherein the processor is further to execute the computer-executable instructions to transmit, over the network, a vehicle advertisement document configured to be placed in said vehicle and to function as a sale sign for said vehicle.

14. The vehicle transaction server of claim 13, wherein said vehicle advertisement document includes said vehicle advertisement number, the vehicle sales price represented by said periodic payment amount, a vehicle make, a vehicle model, a vehicle year of manufacturer, and seller contact information.

15. The vehicle transaction server of claim 9, wherein the processor is further to execute the computer-executable instructions to:
receive the advertisement number over the network from a potential buyer;
access said vehicle information and periodic payment amount using said advertisement number; and
display said vehicle information and periodic payment amount to said potential buyer.

16. The vehicle transaction server of claim 15, wherein the processor is further to execute the computer-executable instructions to:
receive a financing request for the vehicle over the network, and
process said financing request for the vehicle based at least in part on a credit rating of said potential buyer.

17. A computer program product, comprising:
a processor readable medium having processor executable code embodied therein to advertise online vehicle sales, the processor readable medium having:
processor executable program code to receive vehicle information over a network from a private seller of a vehicle;
processor executable program code to calculate a periodic payment amount for said vehicle based on said vehicle information and predetermined financing terms;
processor executable program code to generate a vehicle advertisement number corresponding to said vehicle information and said periodic payment amount; and
processor executable program code to generate an advertisement for said vehicle that includes said vehicle advertisement number and a vehicle sales price represented by said periodic payment amount.

18. The computer program product of claim 17, wherein the processor executable program code to receive comprises processor executable program code to receive said vehicle information into a graphical user interface of a online vehicle transaction server.

19. The computer program product of claim 17, wherein said vehicle information includes one or more of the vehicle sales price, a vehicle make, a vehicle model, a vehicle year of manufacturer, and a vehicle identification number (VIN).

20. The computer program product of claim 19, wherein the processor executable program code to calculate comprises processor executable program code to calculate a monthly payment for said vehicle based on the predetermined financing terms and the vehicle sales price.

21. The computer program product of claim 17, wherein the processor readable medium further comprises processor executable program code to transmit, over the network, a vehicle advertisement document configured to be placed in said vehicle and to function as a sale sign for said vehicle.

22. The computer program product of claim 21, wherein said vehicle advertisement document includes said vehicle advertisement number, the vehicle sales price represented by said periodic payment amount, a vehicle make, a vehicle model, a vehicle year of manufacturer, and seller contact information.

23. The computer program product of claim 17, wherein the processor readable medium further comprises:
processor executable program code to receive the advertisement number over the network from a potential buyer;
processor executable program code to access said vehicle information and periodic payment amount using said advertisement number; and
processor executable program code to display said vehicle information and periodic payment amount to said potential buyer.

24. The computer program product of claim 23, wherein the processor readable medium further comprises:
processor executable program code to receive a financing request for the vehicle over the network; and
processor executable program code to process said financing request for the vehicle based at least in part on a credit rating of said potential buyer.
